(19) United States
(12) Patent Application Publication
(10) Pub. No.: US 2026/0358650 A1
(43) Pub. Date: Nov. 12, 2026

(54) CONTACT LENSE, DESIGN METHOD THEREOF, FABRICATION METHOD THEREOF, AND CORRECTION METHOD THEREOF

(71) Applicants: THE HONG KONG POLYTECHNIC UNIVERSITY, Hong Kong (CN); GOOD Vision Technologies Co., Limited, Hong Kong (CN)

(72) Inventors: Kin Ho CHAN, Hong Kong (CN); Chea-su KEE, Hong Kong (CN); Ki Kit LAU, Hong Kong (CN)

(21) Appl. No.: 19/432,468

(22) Filed: Dec. 24, 2025

(30) Foreign Application Priority Data
May 9, 2025 (CN) 202510597674.2

(51) Int. Cl. G02C 7/02; G02C 7/04

(52) U.S. Cl. CPC G02C 7/027; G02C 7/028; G02C 7/047; G02C 2202/04; G02C 2202/24

(57) ABSTRACT

A contact lens, a design method thereof, a fabrication method thereof, and a correction method thereof are provide by the present application. The method for designing the contact lens includes: obtaining contact lens design parameters; determining a position of an optical center and a position of a geometric center of the contact lens based on the contact lens design parameters; and determining an optical zone by taking the optical center as a center of the optical zone of the contact lens, and determining a peripheral zone by taking the geometric center as a center of the peripheral zone of the contact lens.

### CROSS-REFERENCE TO RELATED APPLICATIONS

Pursuant to 35 U.S.C. § 119 and the Paris Convention, this application claims the benefit of Chinese Patent Application No. 202510597674.2 filed May 9, 2025, the contents of which are incorporated herein by reference.

### BACKGROUND

### Technical Field

The present application relates to the technical field of contact lenses, and more particularly to a contact lens, a design method thereof, a fabrication method thereof, and a correction method thereof.

### Description of Related Art

Contact lenses, also known as invisible glasses, are optical lenses that are directly attached to the front surface of the cornea of the eyeball. They can be used to correct visual problems or meet cosmetic needs, etc.

When designing ordinary corneal contact lenses, it is usually assumed that the center of the lens should be positioned along the visual axis. However, because the cornea is not perfectly symmetrical along the visual axis, the designed contact lens may become misaligned during actual use.

### SUMMARY

It is one of objectives of the present application to provide a contact lens, a design method thereof, a fabrication method thereof, and a correction method thereof, in order to solve the problem of decentration of contact lenses in practical use in existing technologies.

To achieve the above objective, the following technical solutions are adopted in the present application. A method for designing a contact lens is provide. The method for designing the contact lens comprises:
obtaining contact lens design parameters;
determining a position of an optical center and a position of a geometric center of the contact lens based on the contact lens design parameters; and
determining an optical zone by taking the optical center as a center of the optical zone of the contact lens, and determining a peripheral zone by taking the geometric center as a center of the peripheral zone of the contact lens.

In an optional embodiment of the present application, the contact lens design parameters comprise at least one of: a refractive power, ocular surface shape data, a lens total diameter, an optical zone diameter, an edge lift, and a peripheral zone width.

In an optional embodiment of the present application, the contact lens design parameters comprises ocular surface shape data.

The step of determining the position of the optical center and the position of the geometric center of the contact lens comprises:
determining a first position and a second position based on the ocular surface shape data, wherein the first position is a desired position of the optical center and a second position is a desired position of the geometric center; and
placing the optical center at the first position and placing the geometric center at the second position.

In an optional embodiment of the present application, the position of the optical center of the contact lens is determined according to at least one of the following:
a central reference point of ocular morphology data;
a visual axis;
a pupil center;
a coaxially sighted corneal light reflex;
an optimal optical center position obtained by ray tracing simulation combined with wearer ocular data;
an optical center obtained by regression analysis;
an optical center obtained by big data analysis;
an optical center obtained based on empirical values; and
an optical center obtained based on set values.

In an optional embodiment of the present application, the position of the geometric center of the contact lens is determined according to at least one of the following:
a corneal geometric center;
an iris center;
a lens geometric center after a wearer wears the contact lens simulated by a finite element analysis;
a geometric center obtained by a regression analysis;
a geometric center obtained by a big data analysis;
an actual position of the geometric center of the contact lens after the wearer tries on the contact lens;
a position of a treatment zone center after the wearer undergoes a corneal reshaping therapy;
a geometric center obtained based on empirical values; and
a geometric center obtained based on set values.

In an optional embodiment of the present application, after the step of determining the position of the optical center and the position of the geometric center of the contact lens, the method further comprises:
determining a center of an intermediate zone of the contact lens based on the position of the optical center and/or the position of the geometric center, wherein the intermediate zone is a zone between the optical zone and the peripheral zone; and
determining the intermediate zone based on the center of the intermediate zone.

In an optional embodiment of the present application, the intermediate zone comprises a reversal curve zone and an alignment curve zone.
determining the intermediate zone of the contact lens based on the position of the optical center and/or the position of the geometric center comprises:
determining the reversal curve zone based on the position of the optical center; and
determining the alignment curve zone based on the position of the geometric center.

In an optional embodiment of the present application, after determining the optical zone, the method for designing the contact lens further comprises: transforming data of the optical zone into a coordinate system with the geometric center as an origin;
and/or, the center of the intermediate zone of the contact lens is different from the geometric center, and after determining the intermediate zone, the method for designing the contact lens further comprises: transforming data of the intermediate zone into a coordinate system with the geometric center as an origin.

In an optional embodiment of the present application, before determining the peripheral zone, the method for designing the contact lens further comprises: transforming data in the contact lens design parameters configured to determine the peripheral zone into a coordinate system with the geometric center as an origin, and determining the peripheral zone in the coordinate system with the geometric center as the origin;
and/or, the center of the intermediate zone of the contact lens is the same as the geometric center, and before determining the intermediate zone, the method for designing the contact lens further comprises: transforming data in the contact lens design parameters configured to determine the intermediate zone into a coordinate system with the geometric center as an origin, and determining the intermediate zone in the coordinate system with the geometric center as the origin.

The present application also provides a method for fabricating a contact lens, comprising the steps of the method for designing the contact lens as described in the above.

The present application also provides a contact lens designed using the method for designing the contact lens described in the above;
and/or the contact lens is fabricated using the method for fabricating the contact lens as described in the above.

The present application also provides a method for correcting a contact lens. The method is used to correct the contact lens as described in the above. The method comprises:
inspecting the contact lens in an as-worn state to determine whether the optical center and geometric center are in the correct positions;
recording a decentration amount of the optical center and/or a decentration amount of the geometric center, if the optical center and/or geometric center are decentrated relative to the correct positions; and
adjusting and correcting the desired position of the optical center and/or the desired position of the geometric center according to the decentration amount of the optical center and/or the decentration amount of the geometric center.

The beneficial effects of the contact lens, the design method thereof, a fabrication method thereof, and a correction method thereof according to embodiments of the present application are summarized as follows:

Compared with the prior art, in the method for designing the contact lens according to embodiments of the present application, a position of an optical center and a position of a geometric center of the contact lens are respectively determined based on the contact lens design parameters; and an optical zone is determined based on the position of the optical center, and a peripheral zone is determined based on the position of the geometric center. This design decouples the geometric center from the constraint of the position of the optical center, enabling the geometric center to conform to the geometric shape of the wearer's eyeball. On the basis of enhancing the stability of the contact lens, improving the fit between the contact lens and the geometric morphology of the wearer's cornea, and thereby further improving the stability of the contact lens and the stability of the wearer's vision, the method ensures the optical performance and centration of the contact lens, reduces the possibility of decentration, and mitigates the off-axis astigmatism and higher-order aberrations derived from contact lens decentration, thereby ultimately enhancing the wearer's visual quality.

### BRIEF DESCRIPTION OF THE DRAWINGS

To more clearly illustrate the technical solutions in the embodiments of the present application, the drawings used in the description of the embodiments or the prior art will be briefly introduced below. Obviously, the drawings described below are only some embodiments of the present application. For those skilled in the art, other drawings can be obtained based on these drawings without creative effort.

FIG. 1 is a flowchart of a method for designing a contact lens according to an embodiment of the present application;

FIG. 2 is a flowchart of determining an optical center and a geometric center of the contact lens according to an embodiment of the present application;

FIG. 3 is a flowchart of determining an intermediate zone according to an embodiment of the present application;

FIG. 4 is a top view and a horizontal cross-sectional view of a contact lens according to an embodiment of the present application;

FIG. 5 is a top view and a horizontal cross-sectional view of an orthokeratology lens according to an embodiment of the present application;

FIG. 6 is a contour map before coordinate transformation according to an embodiment of the present application;

FIG. 7 is a contour map after coordinate transformation according to an embodiment of the present application;

FIG. 8 is a flowchart of a method for correcting a contact lens according to an embodiment of the present application.

In the drawings, the following reference numerals are adopted: Optical zone 1; Peripheral zone 2; Intermediate zone 3; Reverse curve zone 31; Alignment curve zone 32; Optical center A; Geometric center B.

### DETAILED DESCRIPTION OF THE EMBODIMENTS

To make the technical problems to be solved, technical solutions, and beneficial effects of the present application clearer, the following detailed description is provided in conjunction with the accompanying drawings and embodiments. It should be understood that the specific embodiments described herein are merely illustrative of the present application and are not intended to limit the scope of the present application.

It should be noted that when an element is referred to as being “fixed to” or “disposed/arranged on” another element, it can be directly on or indirectly on that other element. When an element is referred to as being “connected to” another element, it can be directly connected to or indirectly connected to that other element.

It should be understood that the terms “length”, “width”, “upper”, “lower”, “front”, “rear”, “left”, “right”, “vertical”, “horizontal”, “top”, “bottom”, “inner”, “outer”, etc., indicate the orientation or positional relationship based on the orientation or positional relationship shown in the accompanying drawings. They are only for the convenience of describing the present application and simplifying the description, and do not indicate or imply that the device or element referred to must have a specific orientation, or be constructed and operated in a specific orientation. Therefore, they should not be construed as limitations on the present application.

Furthermore, the terms “first” and “second” are used for descriptive purposes only and should not be construed as indicating or implying relative importance or implicitly specifying the number of technical features indicated. Thus, a feature defined as “first” or “second” may explicitly or implicitly include one or more of that feature. In the description of the present application, “multiple” means two or more, unless otherwise explicitly specified.

It should be noted that in the present application, the words “in some embodiments,” “exemplarily,” and “for example” are used to indicate examples, illustrations, or descriptions. Any embodiment or solutions described in the present application as “in some embodiments,” “exemplarily,” or “for example” should not be construed as being more preferred or advantageous than other embodiments or solutions. Specifically, the use of the words “in some embodiments,” “exemplarily,” and “for example” is intended to present the relevant concepts in a specific manner.

Contact lenses mainly include corneal contact lenses, orthokeratology lenses, and scleral lenses. Corneal contact lenses are ordinary contact lenses primarily used for everyday vision correction or cosmetic purposes; for example, common myopia-correcting contact lenses and colored contact lenses are corneal contact lenses. Orthokeratology lenses, abbreviated as OK lenses, are rigid gas-permeable contact lenses that are typically worn overnight to reshape the curvature of the cornea, allowing for myopia correction without the need to wear glasses during the day. Scleral lenses are usually larger in diameter, covering the entire surface of the eyeball and providing support for the cornea. They can be used for conditions such as dry eye, keratoconus, and post-corneal transplant repair, and can also correct refractive errors through their anterior surface curvature design.

When designing contact lenses, the morphological data and related parameters of the eyeball are used as a basis. The data reveal the complex shape of the ocular surface and is crucial for the precise customization of contact lenses. However, the human eye is not perfectly symmetrical, which means that several key ocular reference axes are not perfectly aligned. These reference axes include the visual axis, optical axis, pupillary axis, and line of sight. The visual axis is a straight line from an object to the first nodal point of the eye when the eye looks at it, and can also be approximated as the straight line from the object to the fovea centralis of the retina. The optical axis is a common axis of symmetry of all optical components of the eye, including the cornea and crystalline lens, and can also refer to the axis of symmetry of the cornea alone. The pupillary axis passes through the center of the pupil, and the line of sight is the straight line from the object to the center of the pupil when the eye looks at it.

In actual ocular surface shape data, the most commonly used central reference point is not always aligned with these reference axes. For example, the central reference point in Placido corneal topography is the center of the innermost ring of the Placido rings. This point does not directly correspond to any of the aforementioned reference axes, but it can serve as an approximate visual axis reference point.

When designing conventional contact lenses, it is typically assumed that the lens center should be positioned on the visual axis. However, due to the angle between the visual axis and the optical axis, the cornea is not perfectly symmetrical along the visual axis. This asymmetry can cause lens decentration during actual use, meaning the lens's optical center deviates from the visual axis. Orthokeratology lenses present a similar problem; decentration of orthokeratology lenses can also lead to decentration of the treatment zone, directly affecting refractive correction.

Whether using conventional contact lenses or orthokeratology lenses, lens decentration significantly impacts the wearer's visual quality. Decentration can lead to off-axis astigmatism and higher-order aberrations (HOAs), both of which reduce visual acuity. Off-axis astigmatism occurs when the contact lens is misaligned, causing light to not focus evenly on the retina, resulting in astigmatism. Normally, astigmatism is caused by the irregular ocular morphology, preventing light from focusing at a single point. Off-axis astigmatism, however, is caused by lens decentration, displacing the astigmatic pattern that should be evenly distributed, further affecting vision. Higher-order aberrations are optical aberrations that cannot be corrected by conventional spherical, cylindrical, or spherocylindrical lenses. These aberrations include but not limited to spherical aberration, coma, trefoil aberration, and quadrafoi aberration, which can cause light passing through a contact lens to focus inaccurately on the retina, thereby compromising visual quality. The presence of higher-order aberrations can blur image edges, reduce contrast, and even produce visual artifacts such as glare and starbursts.

Besides affecting visual quality, lens decentration can also alter the lens fit, making the lens too loose or too tight. This increases the risk of contact lens-related complications such as corneal abrasion and hypoxia, negatively impacting the ocular health of the wearer.

To improve lens centrality and/or stability, existing technologies primarily include the following methods:

using one or more advanced ocular surface shape data to make the lens fit the ocular morphology more precisely. For example, the following patent literatures disclose such methods: CN101140357A, CN101957502A, CN102129132A, CN109828385A, CN111343900A, CN114047643A, and U.S. Pat. No. 6,419,359.

By dividing the lens into multiple zones, each zone is made to fit a corresponding zone on the eyeball. For example, the following patent literature disclose such methods: CN211293489U, CN211293490U, CN214098004U, and CN215986772U.

Adding a stabilization zone to the lens achieves dynamic stability by taking into account the effects of blinking, for example, patent literature CN109564357A discloses such a method.

Other more complex lens designs, such as a stretchable inner expansion band and an alternating configuration of at least 12 lobes, are disclosed in patent literature CN218788120U; a design with a hollow center and a connecting arm linking the outer ring to the central optical part is disclosed in patent literature CN117666169A.

However, the aforementioned existing technologies all have one or more of the following drawbacks:
even considering the asymmetry of the human eye, they are still based on visual axis design and do not further consider lens decentration caused by other factors;
the complex design makes lens processing difficult;
a high level of skill and experience from opticians are required; and
difficulties in troubleshooting are caused, for example, when the lens actually misaligns on the wearer, the decentration amount is difficult to intuitively translate into changes in lens parameters, making it difficult for opticians to correct the lens parameters.

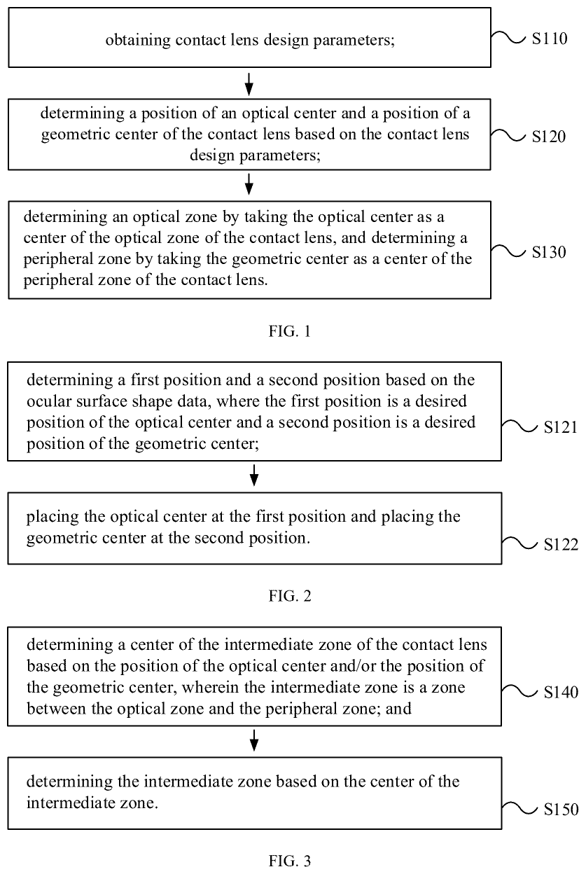

In view of the above problems, referring to FIG. 1, the present application provides a method for designing a contact lens, which includes the following steps:
In step S110, contact lens design parameters are obtained. Contact lens design parameters are the basis for designing contact lenses, and may include ocular surface shape data, lens geometric parameters, optical performance parameters, and material parameters, etc. Their core function is to ensure that the lens matches the ocular morphology, achieving safe, comfortable, and effective visual correction. The specific contact lens design parameters can be collected according to the type of contact lens and the wearer's needs.
In step S120, based on the contact lens design parameters, a position of an optical center and a position of a geometric center of the contact lens are determined. The optical center is a crucial reference point for the optical zone of the contact lens. Light passing through this point will not be deflected, and their propagation direction remains unchanged. For vision-correcting contact lenses, the position of the optical center directly affects the wearer's visual acuity and comfort. Inaccurate optical center positioning may lead to problems such as distorted vision and blurred vision. Contact lenses are typically aligned with or approximately aligned with the eye's visual axis, and their position can be determined based on the contact lens design parameters. The geometric center refers to a central position of the contact lens in terms of its shape; it is determined based on the physical form of the contact lens. The determination of the optical center helps ensure that the contact lens accurately corrects vision and that light is correctly focused on the retina. The determination of the geometric center is also crucial for subsequent design of the peripheral zone of the contact lens and ensuring stable placement of the contact lens on the eyeball.
In step S130, an optical zone is determined by taking the optical center as a center of the optical zone of the contact lens, and a peripheral zone is determined by taking the geometric center as a center of the peripheral zone of the contact lens. The optical zone is a zone on a contact lens used to correct vision or provide a specific visual effect. It is usually located around the optical center of the lens and has a certain diameter and curvature. The optical zone of a contact lens typically includes a front optical zone (FOZ) and a back optical zone (BOZ). The front optical zone refers to the central part of the front surface of the lens that performs refractive functions; its radius of curvature and shape directly affect the refractive power of the lens. The back optical zone, also known as the base curve zone, refers to the central zone of the inner surface of the lens that contacts the cornea; its radius of curvature (base curve) determines the fit between the lens and the cornea, as well as the refractive correction target in orthokeratology.

In this embodiment, the front optical zone and the back optical zone are highly coaxial. Since the optical zone of the contact lens is determined based on the position of the optical center, the optical center can be located on this common central axis. In this case, the optical center serves as the common reference point for both the front optical zone and the back optical zone. Light enters from the front optical zone, propagates along a path centered on the optical center, and exits through the back optical zone, allowing it to be focused onto the retina in a relatively ideal manner, achieving a good vision correction effect. The size, shape, and curvature of the optical zones can be designed according to the position of the optical center and the refractive requirements of the eye.

The peripheral zone is an edge of a contact lens that surrounds the optical zone. It ensures a smooth transition and stable fit between the lens and the ocular surface. The shape of the peripheral zone also determines the efficiency of tear exchange between the lens and the cornea. The peripheral zone has a crucial impact on the comfort and stability of contact lens wear. The design of the peripheral zone takes into account factors such as the curvature of the ocular surface and material properties to ensure a close fit to the eye while maintaining adequate tear exchange, thereby reducing the sensation of foreign body presence and discomfort.

In this embodiment, the optical center and geometric center of the contact lens are independently determined based on the contact lens design parameters, thereby decoupling the geometric center from the constraint of the optical center position and ensuring conformity between the geometric center and the geometric contour of the wearer's eyeball. By determining the peripheral zone through such a geometrically-centered approach, the fit between the lens and the corneal geometry of the wearer is improved. This enhances the positional accuracy of the lens during wear, increases lens stability and visual stability for the wearer, reduces issues of lens fitting changes caused by lens decentration, safeguards ocular health, minimizes lens movement, and improves wearing comfort.

The optical zone of a contact lens is based on the optical center of the contact lens, which can ensure the optical performance of the contact lens. Moreover, the contact lens is worn in an accurate and stable position, which can improve the centering of the lens, reduce the possibility of decentration, ensure that the optical zone can perform its optical characteristics normally, reduce off-axis astigmatism and higher-order aberrations caused by lens decentration, thereby improving the wearer's visual quality.

The contact lens designed in this embodiment features a relatively simple design while ensuring a good fit for the wearer, which facilitate the fabrication. As complex design features are generally unnecessary, it eliminates the requirement for intricate measurement and processing operations. This approach requires only moderate technical skill and experience from dispensers. Through standardized fitting procedures and minimal training, practitioners can rapidly master the fitting process, thereby reduce entry barriers while maintaining fitting accuracy and enhancing the accessibility of vision correction services. Furthermore, because the contact lens designed in this embodiment is based on decoupled optical center and the geometric center, if as-worn decentration occurs, it is usually only necessary to check whether the optical and/or geometric centers are in the desired positions and correct them accordingly, making troubleshooting simpler and more effective.

The contact lens designed by the method of this embodiment may be: a conventional contact lens for correcting refractive errors; a multifocal contact lens for refractive error correction or myopia control; an orthokeratology lens for refractive error correction or myopia control; a therapeutic contact lens for conditions such as keratoconus or post-surgical irregular corneas; or other advanced lens designs with high centration requirements.

In some embodiments of the present application, the contact lens design parameters comprise at least one of: a refractive power, ocular surface shape data, a lens total diameter, an optical zone diameter, an edge lift, and a peripheral zone width.

Among these parameters, refractive power is a key indicator of a lens's ability to correct vision. Determined based on the wearer's refraction results, refractive power compensates for refractive errors such as myopia, hyperopia, and astigmatism, ensuring the lens accurately corrects the wearer's vision problems and provides a clear visual experience. Ocular surface shape data are precise parameters describing the ocular surface crucial for customizing lenses to fit individual ocular morphology. This ensures a perfect match with the ocular surface, reducing discomfort and improving fit and stability. The lens total diameter is the maximum straight-line distance from edge to edge of the contact lens, ensuring sufficient corneal coverage while avoiding insufficient tear exchange due to an overly large diameter or lens displacement due to an overly small diameter. The optical zone diameter is the diameter of the central area on the lens used for vision correction, ensuring clear visual correction within the pupil and avoiding blurred vision or glare caused by edge effects. Edge lift and peripheral zone width are more detailed parameters that can be input in more customized lens designs. Edge lift refers to the degree to which the edge of a lens curls up relative to the lens surface. It affects the gap between the lens and the eyeball, aiding in tear exchange and maintaining lens stability while reducing edge irritation to the eyelids. Peripheral zone width is the width of the transition area between the optical zone and the edge of the lens. An appropriate peripheral zone width helps maintain the overall stability and comfort of the lens.

In some embodiments of the present application, contact lens design parameters include ocular surface shape data. Ocular surface shape data refers to the geometric shape and size information of the eyeball. Obtaining accurate ocular surface shape data is the basis for designing contact lenses suitable for individual eyes, ensuring the fit and comfort of the contact lens, as well as the accuracy of optical performance. Ocular surface shape data is typically obtained through specialized ophthalmic examination equipment, such as keratometry, corneal topography, scleral topography, and optical coherence tomography (OCT), etc.

Referring to FIG. 2, the step of determining the position of the optical center and the position of the geometric center of the contact lens comprises:
In step S121, a first position and a second position based on the ocular surface shape data are determined, in which, the first position is a desired position of the optical center and a second position is a desired position of the geometric center. Ocular surface shape data provide detailed information about the corneal morphology. By analyzing these data, the destined positions of the optical center and the geometric center can be determined. Taking corneal topography as an example, corneal topography is a map of the corneal surface morphology obtained through ophthalmic measurement equipment. The destined position of the optical center, i.e., the first position, can be determined on the corneal topography. Similarly, the destined position of the geometric center, i.e., the second position, can also be determined.
In step S122, the optical center is placed at the first position and the geometric center is placed at the second position. After determining the desired positions of the optical and geometric centers, the optical center and the geometric center of the lens need to be placed in these positions respectively, thus determining the positions of the position of the optical center and the position of the geometric center of the lens are determined.

The ocular surface shape data in this embodiment includes, but is not limited to, keratometry, corneal topography, scleral topography, and optical coherence tomography (OCT). Keratometry refers to the curvature in the central region of the cornea, usually expressed as radius of curvature or power. It is an important indicator of corneal shape and has a direct impact on visual acuity. In contact lens design, keratometry data are crucial for determining the optical zone curvature of the lens. By matching the keratometry, a close fit between the contact lens and the corneal surface of the eye can be ensured, thereby improving visual acuity and comfort. Corneal topography is a morphological map of the corneal surface obtained through ophthalmic measuring device, and shows the undulations on the surface of the cornea, that is, the changes in the curvature of the cornea.

Corneal topography provides detailed morphological information about the corneal surface, helping to identify corneal irregularities or abnormalities. In contact lens design, corneal topography provides more comprehensive and accurate ocular surface shape data than keratometry, ensuring a perfect fit between the lens and the corneal surface. Scleral topography is similar to corneal topography, but it involves measuring the anterior sclera of the eye. The sclera is the tough outer layer of the eyeball, located peripherally to the cornea. Although the application of scleral topography in contact lens design is not as extensive as that of corneal topography, it plays a significant role in understanding the overall morphology of the eye and assessing the fitting of certain specialized contact lenses, such as scleral lenses. Scleral topography allows for a more accurate determination of the overall shape and size of the lens, ensuring a close fit to the posterior part of the eye. Optical coherence tomography uses the principle of light wave interference to provide high-resolution imaging of the internal structures of the eye. OCT can display detailed three-dimensional structures of the anterior part of the eye, including the cornea, sclera, and iris, etc., and its application in contact lens design is similar to that of corneal and scleral topography.

Ocular surface shape data also includes derived parameters, including but not limited to simulated keratometry (Sim-K), apical radius, eccentricity (e), and sagittal height. Simulated keratometry is a corneal curvature value calculated using corneal topography or similar equipment, simulating the way a convectional keratometer measures the curvature of the central cornea. Simulated keratometry helps designers determine the base curve of the lens to ensure a good fit and comfort. Apical radius refers to the radius of curvature at the apex of the cornea, measured using corneal topography or similar equipment. Eccentricity is a parameter describing corneal asphericity; it is often used in conjunction with apical radius or simulated keratometry to describe how the peripheral corneal curvature changes with increasing radial distance from the corneal apex. In contact lens design, considering corneal eccentricity helps optimize the aspheric design of the lens to match the actual shape of the cornea. This helps improve lens fit and visual effect, especially in correcting higher-order aberrations. Sagittal height is the vertical distance from the apex of the cornea along a certain diameter to the corneal surface. Sagittal height provides a detailed view of the corneal surface morphology, helping to identify corneal irregularities and height variations. In contact lens design, understanding sagittal height helps to customize lenses that are better suited to the individual's ocular morphology, especially when dealing with corneal irregularities.

In some embodiments of the present application, the position of the optical center of the contact lens is determined according to at least one of the following: a central reference point of ocular morphology data; a visual axis; a pupil center; a coaxially sighted corneal light reflex; an optimal optical center position obtained by ray tracing simulation combined with wearer ocular data; an optical center obtained by regression analysis; an optical center obtained by big data analysis; an optical center obtained based on empirical values; and an optical center obtained based on set values.

Central reference point of ocular morphology data: The central reference point of the ocular morphology data is generally a point used as a reference or origin when processing and analyzing ocular morphology data, and can be the point corresponding to the optical center of the contact lens.

Visual axis: The visual axis is the straight line from the object to the first nodal point of the eye when the eye looks at it. It can also be approximated as the straight line from the object to the fovea centralis of the retina. It is the main path of light when the eye focuses on an object and is an important reference for the visual system to focus and locate objects. It can also be used as a basis for determining the optical center of a contact lens.

Pupil center: the pupil center is the geometric center of the pupil, that is, the midpoint of the pupil diameter. In the design and fitting of contact lenses, the position of the pupil center is crucial for determining the optical center of the lens, because the position and size of the pupil determine the effective space on the lens that allows light to reach the retina, directly affecting the optical performance of the lens and the wearer's visual experience.

Coaxially sighted corneal light reflex (CSCLR): The coaxial corneal light reflex is the point on the cornea where light strikes and is reflected back under specific lighting conditions. This point is typically located near the center of the pupil and is related to the curvature and shape of the cornea. In contact lens fitting, the coaxial corneal light reflex serves as a reference point for determining the optical center of the lens.

Optimal optical center position obtained by ray tracing simulation combined with wearer ocular data: This method uses ray-tracing technology to simulate the path of light through the wearer's eyes and combines this with the wearer's ocular data to calculate the optimal optical center position. This approach takes into account individual differences and complex optical characteristics of the eye, providing the wearer with the best visual experience and comfort.

Optical center obtained by regression analysis: In contact lens design, regression analysis can be used to analyze the relationship between the wearer's ocular data and the position of the optical center. Through regression analysis, a predictive model can be built to predict the required position of the optical center for different wearers.

Optical center obtained by big data analysis: In contact lens design, big data analysis can be used to analyze a large amount of wearer ocular data and lens fitting effect data, thereby deriving a more accurate and universal range or standard for the position of the optical center.

Optical center obtained based on empirical value: This method relies on the experience and expertise of the optometrist or optician. They determine the position of the optical center based on factors such as the wearer's ocular morphology, visual needs, and wearing habits, combined with their own experience and judgment.

Optical center obtained based on set values: In some cases, the position of the optical center of a lens may be determined based on specific set values or standards. These set values may be based on industry standards, manufacturer's recommendations, or specific application scenarios. For example, in certain types of lens designs, such as multifocal lenses, the position of the optical center may need to be determined according to specific design principles or requirements.

In some embodiments of the present application, the position of the geometric center of the contact lens is determined according to at least one of the following: a corneal geometric center; an iris center; a lens geometric center after a wearer wears the contact lens simulated by a finite element analysis; a geometric center obtained by a regression analysis; a geometric center obtained by a big data analysis; an actual position of the geometric center of the contact lens after the wearer tries on the contact lens; a position of a treatment zone center after the wearer undergoes a corneal reshaping therapy; a geometric center obtained based on empirical values; and a geometric center obtained based on set values.

Corneal geometric center: The corneal geometric center is the center point of the anterior surface of the cornea, typically determined by corneal topography or other corneal measurement techniques. In contact lens design, the corneal geometric center can be used as a reference point to determine the position of the geometric center of the lens.

Iris center: The iris center is the geometric center of the iris. There may be a slight offset between the iris center and the corneal geometric center.

Lens geometric center after a wearer wears the contact lens simulated by a finite element analysis: Finite element analysis (FEA) is used to simulate the geometric center of the lens after the wearer puts on the lens. In contact lens design, FEA can be used to simulate the interaction between the wearer's eye and the lens, thereby predicting the position of the geometric center of the lens. This method takes into account individual differences in the eye and the physical properties of the lens, providing more accurate predictions for lens design.

Geometric center obtained by a regression analysis: In contact lens design, regression analysis can be used to analyze the relationship between the wearer's ocular data and the position of the geometric center of the lens. For example, the relationship between the known corneal elevation asymmetric vector or corneal Q-values difference and lens displacement can be established through regression analysis to predict the required lens geometric center positions for different wearers.

Geometric center obtained by a big data analysis: In contact lens design, regression analysis can be used to analyze the relationship between the wearer's ocular data and the position of the geometric center of the lens. Through regression analysis, a predictive model can be built to predict the required geometric center position of the lens for different wearers.

Actual position of the geometric center of the contact lens after the wearer tries on the contact lens: In the actual fitting process, the wearer may try on lenses with different parameters and assess the lens fit through subjective feelings and objective measurements. In this case, the actual position of the geometric center of the lens may be determined through trying on and adjusting to ensure optimal fit and visual effect.

Position of a treatment zone center after the wearer undergoes a corneal reshaping therapy: The position of the treatment zone after corneal reshaping therapy is crucial for ensuring the effectiveness of the treatment. For a conventional symmetrical orthokeratology lens, the position of the treatment zone center indicates the average position of the geometric center of the lens on the eyeball during wear; setting this as the geometric center of the new lens improves its fit.

Geometric center obtained based on empirical values: This method relies on the experience and expertise of optometrists or opticians. They determine the position of the geometric center of the lens based on factors such as the wearer's ocular morphology, visual needs, and wearing habits, combined with their own experience and judgment. In some cases, this method still has a certain degree of practicality and effectiveness.

Geometric center obtained based on set values: In some cases, the position of the geometric center of the lens may be determined according to specific set values or standards. These set values may be based on industry standards, manufacturer's recommendations, or specific application scenarios. The position of the geometric center may need to be determined according to specific design principles or requirements.

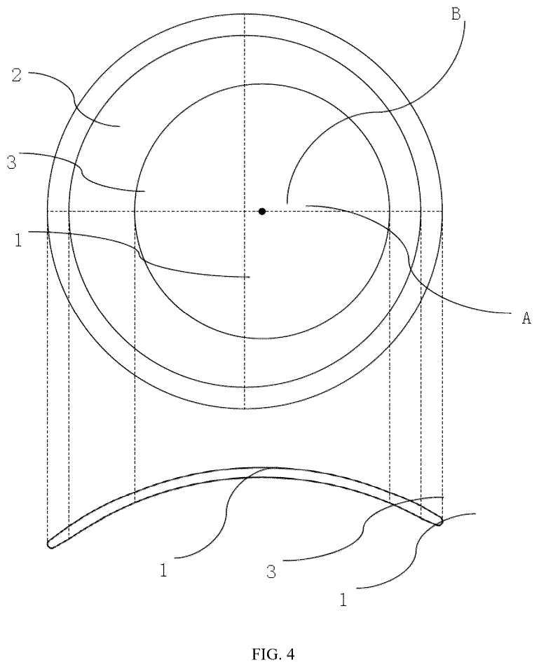

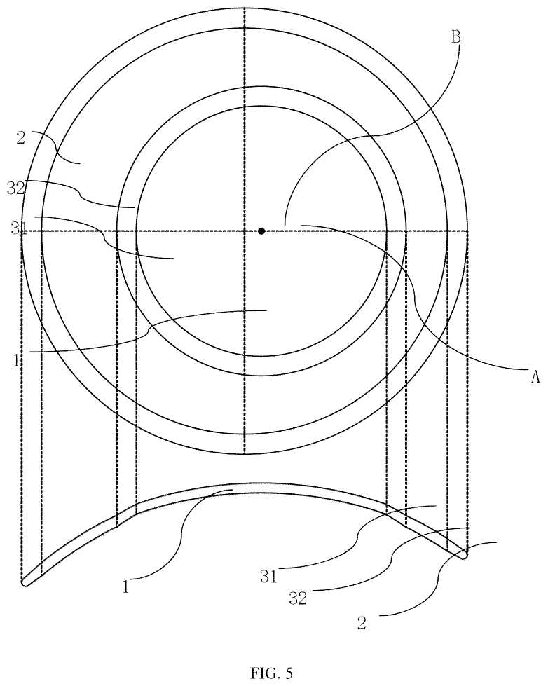

Referring to FIGS. 3-4, in some embodiments of the present application, because some contact lenses have an intermediate zone 3 in addition to the peripheral zone 2 and the optical zone 1, correspondingly, after the step of determining the position of the optical center and the position of the geometric center of the contact lens, the method further comprises:
In step S140, a center of an intermediate zone of the contact lens is determined based on the position of the optical center and/or the position of the geometric center, in which, the intermediate zone is a zone between the optical zone and the peripheral zone. The main function of the intermediate zone is to provide a smooth transition from the optical zone to the peripheral zone to ensure wearer comfort and help the lens better fit the eyeball. In the embodiment shown in FIG. 4, the corneal contact lens includes, from the center to the periphery: the optical zone 1, the intermediate zone 3, and the peripheral zone 2. The optical center A and geometric center B have been determined in the above embodiments; based on this, determining the center position of the intermediate zone ensures a reasonable position, balancing visual needs and fit. Specifically, the center of the intermediate zone 3 can be the optical center A, the geometric center B, or any point between the optical center A and the geometric center B.

In step S150, the intermediate zone is determined based on the center of the intermediate zone. Using the center of the intermediate zone as a reference, extend from the edge of the optical zone to the starting position of the peripheral zone to form the intermediate zone. The specific design of the intermediate zone can also refer to parameters such as ocular surface shape data.

In this embodiment, the center of the intermediate zone is determined based on the previously accurately obtained optical and geometric centers. This method is relatively simple and direct, offering significant advantages. Because it is closely based on the optical center and the geometric center, it effectively ensures the matching degree between the intermediate zone, the peripheral zone, and the optical zone. During actual wear, the highly matched zone setting allows the contact lens to achieve good stability and comfort while ensuring vision correction, greatly improving the performance of the contact lens.

Referring to FIG. 5, in some embodiments of the present application, the intermediate zone 3 comprises a reversal curve zone 31 and an alignment curve zone 32. Contact lenses with an intermediate zone 3 having a reversal curve zone 31 and an alignment curve zone 32 are typically orthokeratology lenses. In orthokeratology lenses, the reversal curve zone 31 is primarily responsible for promoting corneal reshaping through tear fluid dynamics, steeper than the optical zone, can accumulate central tear fluid, creating a pressure difference that causes the central portion of the lens to flatten the corneal surface. Furthermore, the synergistic effect of the reverse curve zone and the optical zone can accelerate corneal reshaping through tear shear force. The alignment curve zone 32 primarily serves to stabilize the lens, ensuring the stability of the optical center. Its curvature design must match the curvature of the mid-peripheral cornea to ensure an accurate fit between the lens and the cornea, preventing displacement.

The step of determining the intermediate zone of the contact lens based on the position of the optical center and/or the position of the geometric center comprises:

the reversal curve zone is determined based on the position of the optical center. The function of the reverse curve zone is to create a pressure difference with the optical zone, flattening the central cornea through tear fluid dynamics, thereby exerting a shaping effect.

In this contact lens design, the reverse curve zone plays a crucial role. The reverse curve zone and the optical zone create a pressure difference, utilizing tear fluid dynamics to flatten the central cornea. The reverse curve zone is determined by the position of the optical center, which is situated at the center of the optical zone. This allows for a better match between the reverse curve zone and the optical zone, thereby improving the modeling effect.

The alignment curve zone is determined based on the position of the geometric center. The alignment curve zone provides stability through mechanical contact. The peripheral zone can also improve wearing stability. The peripheral zone is determined based on the geometric center, and the alignment curve zone is also determined based on the geometric center. Determining the alignment curve zone and the peripheral zone based on the same geometric center can ensure the matching degree between the alignment curve zone and the peripheral zone, prevent the positioning of the alignment curve zone and the peripheral zone from conflicting, and further improve the stability of contact lens wearing.

In some embodiments of the present application, after determining the optical zone, the method for designing the contact lens further comprises: transforming data of the optical zone into a coordinate system with the geometric center as an origin.

In embodiments of the present application, the optical zone is centered on the optical center, while the peripheral zone is centered on the geometric center. When the optical center and the geometric center do not coincide, two reference points arise, which significantly hinders subsequent processing. In this embodiment, after determining the optical zone, the data of the optical zone is transformed into a coordinate system with the geometric center as an origin. Since the peripheral zone itself is determined based on the geometric center, this allows both the optical zone and the peripheral zone to be described using the geometric center as a reference, placing them in the same coordinate system. For example, a new coordinate system can be created where both the optical zone and the peripheral zone are described with the geometric center as the origin, facilitating subsequent processing using equipment such as CNC lathes.

Similarly, in some embodiments of the present application, the center of the intermediate zone of the contact lens is different from the geometric center. After determining the intermediate zone, the method for designing the contact lens further comprises: transforming data of the intermediate zone into a coordinate system with the geometric center as an origin. The center of the intermediate zone may be the optical center, the geometric center, or any point between the optical center and the geometric center. When the center of the intermediate zone is different from the geometric center, the problem of inconsistent coordinates will also occur. Therefore, the data of the intermediate zone can also be transformed into a coordinate system with the geometric center as an origin, so that the intermediate zone is also uniformly described with the geometric center as the reference, thereby allowing the intermediate zone to be processed under a unified coordinate system. Compared with unifying the data of various zones of the contact lens to a coordinate system based on the optical center, unifying the data to a coordinate system with the geometric center as an origin is not only more conducive to processing, but also better ensures the stability and accuracy of the contact lens when worn.

In some embodiments of the present application, before determining the peripheral zone, the method for designing the contact lens further comprises: transforming data in the contact lens design parameters configured to determine the peripheral zone into a coordinate system with the geometric center as an origin, and determining the peripheral zone in the coordinate system with the geometric center as the origin. When designing the peripheral zone, the data in the contact lens design parameters used to determine the peripheral zone, such as ocular morphology data, may not be based on the geometric center, which poses a design challenge. Therefore, in this embodiment, before determining the peripheral zone, the data in the contact lens design parameters used to determine the peripheral zone is transformed into a coordinate system with the geometric center as an origin. After such data conversion, the peripheral zone can be determined in the coordinate system based on the transformed accurate data.

Similarly, the center of the intermediate zone of the contact lens is the same as the geometric center. Before determining the intermediate zone, the method for designing the contact lens further comprises: transforming data in the contact lens design parameters configured to determine the intermediate zone into a coordinate system with the geometric center as an origin, and determining the intermediate zone in the coordinate system with the geometric center as the origin. When the intermediate zone is the same as the geometric center, the design of the intermediate zone faces similar problems as the peripheral zone. Therefore, before determining the intermediate zone, the data in the contact lens design parameters configured to determine the intermediate zone can also be transformed into a coordinate system with the geometric center as an origin. After such data transformation, the intermediate zone can be determined in the coordinate system with the geometric center as the origin based on the transformed accurate data.

Local features of a lens zone, such as its zone boundary and sagittal height, are generally described using a cylindrical coordinate system with the zone center as the origin. The coordinate transformation in this embodiment is explained below using the zone boundary and sagittal height as examples.

Taking the coordinate transformation of the zone boundary as an example, to describe the zone boundary, let d and @ correspond to an decentration amount and a decentration angle of the lens zone center relative to the lens geometric center, respectively. The function r(θ) denotes a radial distance from the lens geometric center to the lens zone boundary along a semi-meridian with an azimuth angle of θ in a coordinate system that takes the lens geometric center as the origin.

A general solution for r(θ): The zone boundary with an arbitrary convex geometry.

If the zone boundary of the lens has an arbitrary convex geometry, and can be described by r₀(θ₀) with the zone center as the origin, r(θ) may not necessarily have a closed-form solution. In this case, a numerical approximation can be used. First, obtain the mapping function t(θ) between the azimuth angle θ₀ of the zone coordinate system and the azimuth angle θ₀ of the new coordinate system using numerical approximation:

$$t ( θ ) = {arg min}_{{θ}_{0}} \vert a tan 2 ( {r}_{0} ( {θ}_{0} ) sin {θ}_{0} + d sin ϕ , {r}_{0} ( {θ}_{0} ) cos {θ}_{0} + d cos ϕ ) - θ \vert$$

When the boundary is convex, it can be proven that θ corresponds to one and only one θ₀, and θ₀ also corresponds to one and only one θ. Substituting t(θ) yields:

r(θ)={square root over (r₀(t(θ))²+d²+2dr₀(t(θ))cos(t(θ)−θ))}

Special solution to r(θ): The zone boundary is elliptical.

If the lens zone is an ellipse with a semi-major axis of α and a semi-minor axis of b, and the major axis forms an angle α with the horizontal axis, then it follow that:

$$r ( θ ) = \frac{- B ( θ ) + \sqrt{Δ ( θ )}}{2 A ( θ )}$$

where:

A(θ)=a²−(a²−b²)cos²(α−θ);

B(θ)=−2d(a² cos(φ−θ)−(a²−b²)cos(α−θ)cos(α−θ));

Δ(θ)=2a²b²(a²+b²−(a²−b²)cos(2(σ−θ))+2d² sin²(φ−θ))ₒ

Special Solution 2 for r(θ): The zone boundary is circular.

If the lens zone is a circle with diameter D, the formula obtained from Special Solution 1 can be further simplified:

$$r ( θ ) = d cos ( ϕ - θ ) + \sqrt{{( \frac{D}{2} )}^{2} - {d}^{2} {sin}^{2} ( ϕ - θ )}$$

Taking a circular zone with a diameter of 6 mm as an example, the value of r(θ) is shown in the table below when the zone center is horizontally decentrated to the right:

| Azimuth | Decentration amount d | | | | | |
|---|---|---|---|---|---|---|
| angle θ | 0.000000 | 0.200000 | 0.400000 | 0.600000 | 0.800000 | 1.000000 |
| 0.0° | 3.000000 | 3.200000 | 3.400000 | 3.600000 | 3.800000 | 4.000000 |
| 22.5° | 3.000000 | 3.183799 | 3.365644 | 3.545528 | 3.723442 | 3.899372 |
| 45.0° | 3.000000 | 3.138086 | 3.269480 | 3.394113 | 3.511869 | 3.622583 |
| 67.5° | 3.000000 | 3.070841 | 3.130225 | 3.177952 | 3.213676 | 3.236882 |
| 90.0° | 3.000000 | 2.993326 | 2.973214 | 2.939388 | 2.891366 | 2.828427 |
| 112.5° | 3.000000 | 2.917768 | 2.824078 | 2.718732 | 2.601382 | 2.471515 |
| 135.0° | 3.000000 | 2.855243 | 2.703794 | 2.545584 | 2.380499 | 2.208369 |
| 157.5° | 3.000000 | 2.814248 | 2.626540 | 2.436873 | 2.245235 | 2.051613 |
| 180.0° | 3.000000 | 2.800000 | 2.600000 | 2.400000 | 2.200000 | 2.000000 |
| 202.5° | 3.000000 | 2.814248 | 2.626540 | 2.436873 | 2.245235 | 2.051613 |
| 225.0° | 3.000000 | 2.855243 | 2.703794 | 2.545584 | 2.380499 | 2.208369 |
| 247.5° | 3.000000 | 2.917768 | 2.824078 | 2.718732 | 2.601382 | 2.471515 |
| 270.0° | 3.000000 | 2.993326 | 2.973214 | 2.939388 | 2.891366 | 2.828427 |
| 292.5° | 3.000000 | 3.070841 | 3.130225 | 3.177952 | 3.213676 | 3.236882 |
| 315.0° | 3.000000 | 3.138086 | 3.269480 | 3.394113 | 3.511869 | 3.622583 |
| 337.5° | 3.000000 | 3.183799 | 3.365644 | 3.545528 | 3.723442 | 3.899372 |

Taking the coordinate transformation of the lens sagittal height as an example, the following transformations related to sagittal height may be applied, regardless of whether a lens zone is designed centered on the optical center or the geometric center. For instance, after the optical zone and/or intermediate zone are designed based on the determined optical center, they need to be re-defined with the geometric center as the origin, transforming them into a coordinate system benchmarked against the geometric center. Similarly, when designing the peripheral zone and/or intermediate zone, the ocular morphology at those positions must be considered. However, if the reference point for the ocular morphology data does not lie at the geometric center of the lens, it must be transformed into a coordinate system with the geometric center of the lens as its origin to enable precise design of the peripheral and/or intermediate zones.

The general solution for the sagittal height of the lens: The zone is an arbitrary curved surface.

If the zone is an arbitrary surface including but not limited to spheres, tori, hyperboloids, and freeform surfaces, and the sagittal height z of any point can be described in a cylindrical coordinate system centered at the zone center as:

z=f₀(ρ₀,θ₀)

By substituting:

ρ₀=\sqrt{ρ²+d²−2dρ cos(φ−θ)}

θ₀=atan2(ρ sin θ−d sin φ,ρ cos θ−d cos φ)

We obtain, in the cylindrical coordinate system with the geometric center as the origin:

z=f(ρ,θ)=f₀(\sqrt{ρ²+d²−2dρ cos(φ−0)},atan2(ρ sin θ−d sin φ,ρcos θ−d cos φ))

A special solution for sagittal height of the lens: the zone is a spherical surface.

Assuming the zone is a spherical surface with a radius R and vertex height z₀, the sagittal height z at any point can be described in a cylindrical coordinate system centered at the zone center as:

$$z = {f}_{0} ( {ρ}_{0} ) = {z}_{0} - R + \sqrt{{R}^{2} - {ρ}_{0}^{2}}$$

In the cylindrical coordinate system with the lens geometric center as the origin, this becomes:

z=f(ρ,θ)=z₀−R+\sqrt{R²−ρ²−d²+2dρ cos(φ−θ)}

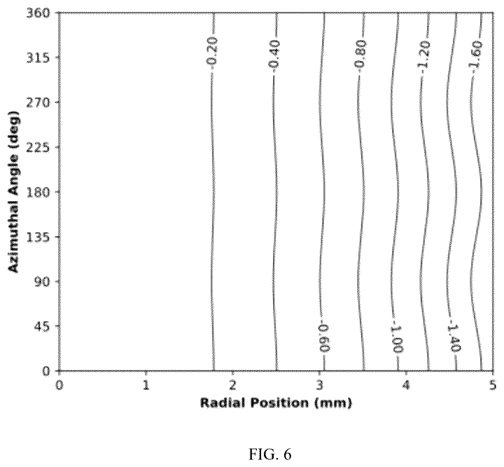

Taking a hyperboloid cornea (with a horizontal vertex radius R_{H}=8, horizontal asphericity Q_{H}=−0.25, vertical vertex radius R_{V}=7.8, vertical asphericity Q_{V}=−0.05) as an example, its sagittal height is sampled using its vertex as the origin of the cylindrical coordinate system. The contour map of the resulting topography is shown in FIG. 6.

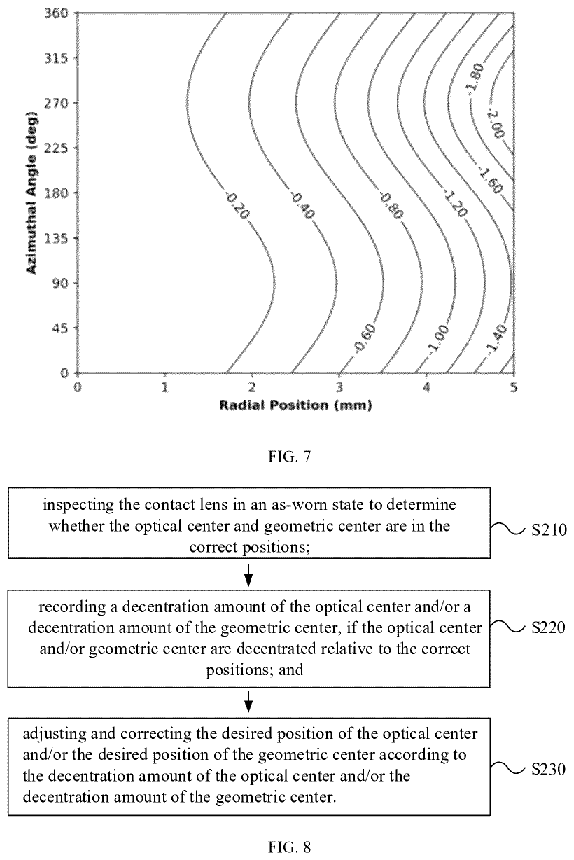

If the geometric center of the lens is 0.5 mm inferior to its vertex, sampling its sagittal height with the geometric center of the lens as the origin of the cylindrical coordinate system, and applying the above conversion formula, the contour lines are shown in FIG. 7.

Comparing FIG. 6 and FIG. 7, it is clear that their shapes are significantly different. This demonstrates that only through coordinate system transformation can the contact lens be accurately designed with a defined optical and geometric center.

The present application also provides a method for fabricating a contact lens. This method is used to fabricate contact lenses designed using the method for designing the contact lens described in the above embodiments. Because the contact lenses designed in the above embodiments maintain a relatively simple design while ensuring a good fit for the wearer, the fabricating process of contact lenses is simplified, thereby improving fabricating efficiency and reducing costs.

The present application also provides a contact lens, which is designed using the method for designing the contact lens of the above embodiments and/or fabricated using the contact lens fabricating methods of the above embodiments. The contact lens of this embodiment can guarantee the optical performance of the contact lens, and the contact lens is accurately positioned and stably worn, improving lens centrality, reducing the possibility of decentration, ensuring that the optical zone can normally perform its optical characteristics, reducing off-axis astigmatism and higher-order aberrations caused by lens decentration, thereby improving the wearer's visual quality.

Although the accuracy of the contact lenses designed and fabricated in the present application embodiment can be significantly improved, problems such as incorrect position of the optical center of the contact lens and unsatisfactory treatment zone position of the orthokeratology lens may still occur due to human error and other reasons, resulting in unsatisfactory contact lens fitting. Therefore, referring to FIG. 8, the present application also provides a contact lens correction method. This correction method is used to correct the contact lenses of the above embodiments. The correction method comprises:

The contact lens in an as-worn state is inspected to determine whether the optical center and geometric center are in the correct positions. The inspection here is the inspection after the contact lens is worn, especially in cases where the wearer reports unsatisfactory results. The inspection equipment can be implemented using slit-lamp or corneal topography. Specifically, slit-lamp inspection can be performed by a fitting personnel using a slit lamp combined with a microscope to observe the dynamic and static fitting states of the lens. The dynamic fitting state can confirm whether the lens is centered and whether the range of motion is within the ideal range. The static fitting state can be checked by cobalt blue light staining to examine the fit between each curve zone of the lens and the cornea, and to identify problems such as air bubbles or insufficient coverage. Corneal topography analyzes the corneal morphology after contact lens wear with three-dimensional analysis, observing the corneal reshaping effect, such as treatment zone coverage and changes in corneal curvature. These methods also allow direct observation of whether the optical and geometric centers are in the correct positions. The correct positions refer to where the optical and geometric centers should be after contact lens wear.

If the optical center and/or geometric center are decentrated relative to the correct positions, a decentration amount of the optical center and/or a decentration amount of the geometric center are recorded. Specifically, decentration may be present in the optical center, the geometric center, or both. Once decentration is confirmed, the decentration amount—which may include distance, direction, spatial coordinates, etc.—must be accurately recorded. If the optical center and/or geometric center show no decentration from their correct positions, other parameters can be checked.

The desired position of the optical center and/or the desired position of the geometric center are adjusted and corrected according to the decentration amount of the optical center and/or the decentration amount of the geometric center. The desired position herein refers to the desired position mentioned in the above contact lens designing method. It's important to note that if the optical center is decentrated, then the desired position of the optical center is corrected; if the geometric center is decentrated, the desired position of the geometric center is corrected; and if both the optical center and the geometric center are decentrated, then both the desired position of the optical center and/or the desired position of the geometric center are corrected. Since the desired position is the fundamental positioning for the design, correcting it can greatly improve the contact lens's performance.

Overall, the contact lens correction method of embodiments of the present application is compatible with the contact lens designing method of the above embodiments, and can improve the fitting effect of the contact lens in an intuitive and predictable way. It provides a convenient operating method for opticians, enabling them to easily and accurately correct the contact lens, and greatly improves the efficiency and quality of the fitting work.

In the above embodiments, the descriptions of embodiments have different focuses. Parts not described in detail or in a particular embodiment can be referred to in the relevant descriptions of other embodiments. Furthermore, the above contents are merely specific implementation manners of the present application, but the protection scope of the present application is not limited thereto. Any variations or substitutions that can be easily conceived by those skilled in the art within the scope of the technology disclosed in the present application should be included within the protection scope of the present application.

What is claimed is:

1. A method for designing a contact lens, the method comprising:
obtaining contact lens design parameters;
determining a position of an optical center and a position of a geometric center of the contact lens based on the contact lens design parameters; and
determining an optical zone by taking the optical center as a center of the optical zone of the contact lens, and determining a peripheral zone by taking the geometric center as a center of the peripheral zone of the contact lens.

2. The method for designing the contact lens according to claim 1, wherein the contact lens design parameters comprise at least one of: a refractive power, ocular surface shape data, a lens total diameter, an optical zone diameter, an edge lift, and a peripheral zone width.

3. The method for designing the contact lens according to claim 2, wherein the contact lens design parameters comprises ocular surface shape data;
the step of determining the position of the optical center and the position of the geometric center of the contact lens comprises:
determining a first position and a second position based on the ocular surface shape data, wherein the first position is a desired position of the optical center and a second position is a desired position of the geometric center; and
placing the optical center at the first position and placing the geometric center at the second position.

4. The method for designing the contact lens according to claim 1, wherein the position of the optical center of the contact lens is determined according to at least one of the following:
a central reference point of ocular morphology data;
a visual axis;
a pupil center;
a coaxially sighted corneal light reflex;
an optimal optical center position obtained by ray tracing simulation combined with wearer ocular data;
an optical center obtained by regression analysis;
an optical center obtained by big data analysis;
an optical center obtained based on empirical values; and
an optical center obtained based on set values.

5. The method for designing the contact lens according to claim 1, wherein the position of the geometric center of the contact lens is determined according to at least one of the following:
a corneal geometric center;
an iris center;
a lens geometric center after a wearer wears the contact lens simulated by a finite element analysis;
a geometric center obtained by a regression analysis;
a geometric center obtained by a big data analysis;
an actual position of the geometric center of the contact lens after the wearer tries on the contact lens;
a position of a treatment zone center after the wearer undergoes a corneal reshaping therapy;
a geometric center obtained based on empirical values; and
a geometric center obtained based on set values.

6. The method for designing the contact lens according to claim 1, wherein after the step of determining the position of the optical center and the position of the geometric center of the contact lens, the method further comprises:
determining a center of an intermediate zone of the contact lens based on the position of the optical center and/or the position of the geometric center, wherein the intermediate zone is a zone between the optical zone and the peripheral zone; and
determining the intermediate zone based on the center of the intermediate zone.

7. The method for designing the contact lens according to claim 6, wherein the intermediate zone comprises a reversal curve zone and an alignment curve zone; and
determining the intermediate zone of the contact lens based on the position of the optical center and/or the position of the geometric center comprises:
determining the reversal curve zone based on the position of the optical center; and
determining the alignment curve zone based on the position of the geometric center.

8. The method for designing the contact lens according to claim 6, wherein
after determining the optical zone, the method for designing the contact lens further comprises: transforming data of the optical zone into a coordinate system with the geometric center as an origin.

9. The method for designing the contact lens according to claim 8, wherein
the center of the intermediate zone of the contact lens is different from the geometric center, and after determining the intermediate zone, the method for designing the contact lens further comprises: transforming data of the intermediate zone into the coordinate system with the geometric center as the origin.

10. The method for designing the contact lens according to claim 6, wherein
the center of the intermediate zone of the contact lens is different from the geometric center, and after determining the intermediate zone, the method for designing the contact lens further comprises: transforming data of the intermediate zone into a coordinate system with the geometric center as an origin.

11. The method for designing the contact lens according to claim 6, wherein
before determining the peripheral zone, the method for designing the contact lens further comprises:
transforming data in the contact lens design parameters configured to determine the peripheral zone into a coordinate system with the geometric center as an origin, and determining the peripheral zone in a coordinate system with the geometric center as an origin.

12. The method for designing the contact lens according to claim 11, wherein
the center of the intermediate zone of the contact lens is the same as the geometric center, and before determining the intermediate zone, the method for designing the contact lens further comprises: transforming data in the contact lens design parameters configured to determine the intermediate zone into the coordinate system with the geometric center as the origin, and determining the intermediate zone in the coordinate system with the geometric center as the origin.

13. The method for designing the contact lens according to claim 6, wherein
the center of the intermediate zone of the contact lens is the same as the geometric center, and before determining the intermediate zone, the method for designing the contact lens further comprises: transforming data in the contact lens design parameters configured to determine the intermediate zone into a coordinate system with the geometric center as an origin, and determining the intermediate zone in the coordinate system with the geometric center as the origin.

14. A method for fabricating a contact lens, comprising the steps of the method for designing the contact lens according to claim 1.

15. A method for correcting a contact lens, the method comprises:
fabricating a contact lens, comprising the steps of the method for designing the contact lens according to claim 1;
inspecting the contact lens in an as-worn state to determine whether the optical center and geometric center are in the correct positions;
recording a decentration amount of the optical center and/or a decentration amount of the geometric center, if the optical center and/or geometric center are decentrated relative to the correct positions; and
adjusting and correcting the desired position of the optical center and/or the desired position of the geometric center according to the decentration amount of the optical center and/or the decentration amount of the geometric center.

16. The method for correcting the contact lens according to claim 15, wherein the contact lens design parameters comprise at least one of: a refractive power, ocular surface shape data, a lens total diameter, an optical zone diameter, an edge lift, and a peripheral zone width.

17. The method for correcting the contact lens according to claim 16, wherein
the contact lens design parameters comprises ocular surface shape data;
the step of determining the position of the optical center and the position of the geometric center of the contact lens comprises:
determining a first position and a second position based on the ocular surface shape data, wherein the first position is a desired position of the optical center and a second position is a desired position of the geometric center; and
placing the optical center at the first position and placing the geometric center at the second position.

18. The method for correcting the contact lens according to claim 15, wherein after the step of determining the position of the optical center and the position of the geometric center of the contact lens, the method further comprises:
determining a center of an intermediate zone of the contact lens based on the position of the optical center and/or the position of the geometric center, wherein the intermediate zone is a zone between the optical zone and the peripheral zone; and
determining the intermediate zone based on the center of the intermediate zone.

19. The method for correcting the contact lens according to claim 18, wherein
the intermediate zone comprises a reversal curve zone and an alignment curve zone; and
determining the intermediate zone of the contact lens based on the position of the optical center and/or the position of the geometric center comprises:
determining the reversal curve zone based on the position of the optical center; and
determining the alignment curve zone based on the position of the geometric center.

20. The method for correcting the contact lens according to claim 18, wherein
after determining the optical zone, the method for designing the contact lens further comprises: transforming data of the optical zone into a coordinate system with the geometric center as an origin; and
the center of the intermediate zone of the contact lens is different from the geometric center, and after determining the intermediate zone, the method for designing the contact lens further comprises: transforming data of the intermediate zone into the coordinate system with the geometric center as the origin.
